(19) United States
(12) Patent Application Publication
(10) Pub. No.: US 2026/0355977 A1
(43) Pub. Date: Nov. 12, 2026

(54) MANIPULATION PROTECTION FOR A HANDHELD DEVICE

(71) Applicant: KUKA Deutschland GmbH, Augsburg (DE)

(72) Inventor: Sergiy Ostrovski, Aichach (DE)

(73) Assignee: KUKA Deutschland GmbH, Augsburg (DE)

(21) Appl. No.: 19/130,605

(22) PCT Filed: Oct. 20, 2023
(86) PCT No.: PCT/EP2023/079214

§ 371 Date: May 16, 2025

(30) Foreign Application Priority Data
Nov. 23, 2022 (DE) 10 2022 212 498.7

(51) Int. Cl. B25J 13/02; G06F 3/01

(52) U.S. Cl. CPC B25J 13/02; G06F 3/011

(57) ABSTRACT

A handheld device includes a casing, a sensor device arranged on the casing and having at least one sensor for detecting a manipulation of the handheld device, and an evaluation device arranged on the casing for initiating a manipulation reaction as a result of a manipulation detected by the sensor device. The handheld device is a handheld operating device for operating a robot and may include at least one energy store arranged on the casing for supplying the evaluation device with electrical energy. The sensor may include a sliding arrangement with at least one sliding track and at least one sliding contact for producing an electrical contact to the sliding track in a variably adjustable position. A value of an electrical parameter of the sliding arrangement determined by the position is stored and/or the sliding arrangement is designed such that this position is lost as a result of a manipulation.

### CROSS-REFERENCE TO RELATED APPLICATIONS

This application is a national phase application under 35 U.S.C. § 371 of International Patent Application No. PCT/EP2023/079214, filed Oct. 20, 2023 (pending), which claims the benefit of priority to German Patent Application No. DE 10 2022 212 498.7, filed Nov. 23, 2022, the disclosures of which are incorporated by reference herein in their entirety.

### TECHNICAL FIELD

The present invention relates to a handheld device, to a system for operating a robot, and to a method for producing and/or operating the handheld device.

### SUMMARY

It is the object of the present invention to improve manipulation protection.

This object is achieved by a handheld device having the features of claim 1. Claims 7-9 seek protection for a system for operating a robot with a handheld device described herein, and a method for producing and/or operating a handheld device described herein. The dependent claims relate to advantageous further embodiments.

According to one embodiment of the present invention, a handheld device, in particular a device that can be carried in one hand, has a casing, a sensor device which is arranged on, in particular partially or completely in, the casing and has one or more sensors, by means of which a manipulation, in particular physical or mechanical manipulation, of the handheld device, in particular of the casing, is or can be detected, and/or which is/are configured and/or used for this purpose, and an evaluation device arranged on, in particular partially or completely in, the casing, which initiates a manipulation reaction as a result of a manipulation, in particular physical or mechanical manipulation, of the handheld device, in particular of the casing, detected by means of the sensor device, in a further development carries out such a manipulation reaction, and/or is configured and/or used for this purpose.

In one embodiment, the handheld device has a control device which, in a further development, is arranged on, in particular partially or completely in, the casing and/or is formed integrally with the evaluation device, in a further development is the evaluation device and/or is identical to the evaluation device. In this way, in one embodiment, a (more) compact construction can be realized. In another embodiment, the control device and evaluation device are designed separately. This can increase security and/or improve retrofitability and/or maintenance in one embodiment.

The casing is in two or more parts in one embodiment. A manipulation which is or can be detected by means of the sensor device can in particular comprise, in particular be, an opening of the casing, in particular at least partial separation of at least two of its parts from one another. By detecting a manipulation of this kind and a corresponding manipulation reaction, undesirable consequences of unauthorized access to, in particular electronic, components in the casing, such as in particular the control device, in particular maintenance by non-authorized personnel, can be avoided or reduced in one embodiment.

According to one aspect of the present invention, the handheld device is a handheld operating device that is used and/or configured to operate a robot, in a further development in terms of hardware and/or software, in one embodiment by at least one emergency stop, in particular at least one emergency stop input device, and/or a (correspondingly) safe embodiment and/or an input interface for entering user inputs to operate the robot. In one embodiment, the robot has at least three, in particular at least six, in one embodiment at least seven, actuated links and/or (movement) axes, in particular rotational links and/or rotational axes, in one embodiment a robot arm with at least three, in particular at least six, and in one embodiment at least seven, actuated links and/or (movement) axes, in particular rotational links and/or rotational axes.

Accordingly, in one embodiment, it has a communication interface for communication, in one embodiment wirelessly or by wire, with the robot and/or a robot controller for controlling the robot.

According to one embodiment of this aspect of the present invention, the handheld (operating) device, in a further development the control device, outputs signals for operating the robot as a result of user inputs, in one embodiment as a result of user inputs entered via an input interface, in one embodiment via the communication interface and/or wirelessly or by wire and/or to the robot and/or the robot controller.

According to one embodiment of this aspect of the present invention, a system for operating the robot with a handheld (operating) device described here for operating the robot is protected, wherein the system in one embodiment comprises the robot and/or the robot controller for controlling the robot.

This aspect is based in particular on the idea of preventing or making it more difficult for non-authorized personnel to carry out maintenance on a robot handheld operating device and/or of preventing or reducing undesirable consequences of such maintenance during subsequent operation of the (robot with the) handheld operating device, which may sometimes only occur some time after maintenance by non-authorized personnel.

According to one aspect of the present invention, the handheld device has at least one energy store, in particular a voltage buffer, arranged on, in particular partially or completely in, the casing, in one embodiment, one or more Li-ion cells, one or more capacitive storage cells or the like, which supply/supplies or is/are configured to supply the evaluation device with electrical energy at least temporarily, in one embodiment at least when the handheld device or control device is powered off.

In one embodiment, this makes it possible to increase security and/or to realize or improve energy-autonomous monitoring of the handheld device for manipulation, particularly when the handheld device is disconnected from an external power supply and/or the control device, in particular the handheld device, is powered off.

In one embodiment, the sensor device is also supplied with electrical energy at least temporarily by the at least one energy store. Likewise, in one embodiment, the sensor device can also have its own power supply arranged on, in particular partially or completely in, the casing and/or, in particular by manipulation, generate energy itself and/or be supplied with electrical energy by a power supply of the handheld device. In general, in a preferred embodiment, the handheld device, in particular its evaluation device and in a further development also its sensor device, are designed to be (energy-) autonomous in such a way that, despite the control device, in particular the handheld device, being powered off and/or the control device, in particular the handheld device, being disconnected from an external power supply, a manipulation of the handheld device, in particular of the casing, is detected by means of the sensor device and the manipulation reaction is initiated, in particular carried out, by the evaluation device, in one embodiment even when the control device, in particular the handheld device, is still powered off and/or still disconnected from an external power supply, in one embodiment only after the control device, in particular the handheld device, has been switched on and/or (re) connected to an external power supply.

This aspect can be particularly advantageously combined with the aspect that the handheld device is a handheld operating device for operating a robot, but is not limited thereto. The detection and triggering of a manipulation reaction when the control device or handheld device is powered off and/or disconnected from an external power supply can be particularly advantageously combined with an activation of the evaluation device from a standby state, as explained below, which is preferably supplied with electrical energy by the energy store or voltage buffer. The detection and triggering of a manipulation reaction when the control device or handheld device is powered off and/or disconnected from an external power supply can be combined particularly advantageously with a sliding arrangement aspect explained below, which provides a sensor that is irreversibly adjusted or actuated as a result of a manipulation even when de-energized, which sensor can indicate a corresponding manipulation and trigger a manipulation reaction even after the control device, in particular the handheld device, has been switched on and/or (re) connected to an external power supply.

According to one aspect of the present invention, the sensor, or one or more of the sensors of the sensor device, (each) has/have a sliding arrangement, wherein the, or one or more, sliding arrangements each have at least one, preferably at least double-path, sliding track, preferably with at least two parallel paths, and at least one sliding contact, wherein this sliding contact of the (corresponding) sliding arrangement establishes an electrical contact with this sliding track of this sliding arrangement, preferably its at least two, in one embodiment, parallel, paths, in a position (of the sliding contact and the sliding track relative to each other, in particular of the sliding contact relative to and/or on the sliding track, or of the sliding track relative to and/or on the sliding contact), wherein this (or each of these) position(s) is/are variably adjustable and/or adjusted, wherein
a) a value of an electrical parameter of the (corresponding) sliding arrangement, preferably its sliding track, determined by this position is stored, wherein this value of the electrical parameter characterizes a non-manipulated handheld device in one embodiment, and/or is stored in the evaluation or control device; and/or
b) the sliding arrangement, in one embodiment the sliding contact and/or the sliding track, is designed in such a way that this position is lost as a result of a manipulation (of the handheld device or casing);
and/or the sensor device, its sensor(s) and/or the sliding arrangement(s) or the sliding track(s) thereof and/or the sliding contact(s) thereof is/are configured and/or used for this purpose.

Accordingly, according to an embodiment of this aspect, for producing the handheld device, the position of the at least one sliding arrangement, in particular of the at least one sliding contact and/or of the at least one sliding track, is adjusted, particularly preferably randomly, and/or a value of an electrical parameter of this sliding arrangement (of the non-manipulated handheld device) determined by this position is stored, preferably in the evaluation or control device.

Additionally or alternatively, according to an embodiment of this aspect, in a method for operating the handheld device, the evaluation device compares a detected value of the electrical parameter determined by the position, in particular of this sliding contact and/or this sliding track, of this sliding arrangement with the stored value of the electrical parameter of this sliding arrangement, and detects a manipulation if a deviation between the detected and stored value of the electrical parameter fulfills a deviation condition, in one embodiment exceeds a predetermined tolerance or the like.

Using the position of a sliding contact and a sliding track of a sliding arrangement relative to each other, in a further development of a sliding contact relative to and/or on a sliding track of a sliding arrangement or a sliding track relative to and/or on a sliding contact of a sliding arrangement, (a value of) an electrical parameter, in particular an electrical resistance or the like, of this sliding arrangement is determined. Accordingly, in one embodiment, an electrical parameter in the context of the present invention and/or its value depends on an electrical resistance of the (corresponding) sliding arrangement, and can in particular comprise, in particular be, the electrical resistance. Because (of the sliding arrangement being configured in such a way that) this position is lost as a result of a manipulation, preferably irreversibly, a deviation between a value of the electrical parameter detected after the manipulation and the value stored (before the manipulation) fulfills a deviation condition, such that a manipulation can be detected (more) reliably and/or (more) easily. Because the position is variably, in particular randomly, adjustable and/or adjusted, in particular by a manufacturer or authorized personnel, the probability that the same value of the electrical parameter will be achieved again by repositioning the sliding contact and/or the sliding track after an unauthorized manipulation can be reduced or minimized. In one embodiment, the sliding contact electrically connects or electrically short-circuits at least two paths of the sliding track, such that the resistance between terminals of these paths or this sliding track changes according to the position.

This aspect can be combined with the aspect that the handheld device is a handheld operating device for operating a robot and/or with the aspect that the evaluation device is at least temporarily supplied with electrical energy by at least one energy store arranged on the casing, wherein the combination with the aspect that the handheld device is a handheld operating device for operating a robot is particularly preferred; however, the sliding arrangement aspect is not limited to a combination with one or more other aspects.

In one embodiment of the sliding arrangement aspect, the sliding track is ring-shaped and/or the sliding contact is movably, in a further development rotatably, mounted relative to the sliding track, in one embodiment arranged on a rotatably mounted rotor (relative to the sliding track), and/or the sliding track is movably, in a further development rotatably, mounted, in particular relative to the sliding contact, in one embodiment arranged on a rotatably mounted rotor (relative to the sliding contact). Accordingly, in one embodiment, the variably adjustable or adjusted position of the sliding arrangement, in particular of the sliding contact and/or the sliding track, which determines the value of the electrical parameter of the sliding arrangement, comprises a position, in a further development rotational position or angular orientation, of the sliding contact and/or rotor with the sliding contact arranged thereon relative to the sliding track, or the sliding track and/or the rotor with the sliding track arranged thereon relative to the sliding contact.

As a result, in one embodiment, the position of the sliding arrangement, in particular of the sliding contact and/or the sliding track, can be variably adjusted in a compact and/or simple manner. In one embodiment, the sliding contact can contact the sliding track, which in particular is not ring-shaped but rather, for example, at least partially linear, in a random and factory-set translational position, which is lost as a result of a manipulation, in particular due to a resulting loss of a friction connection between the sliding contact and the sliding track.

Additionally or alternatively, in one embodiment the position of the sliding arrangement, in particular of the sliding contact and/or the sliding track, is adjusted, in particular fixed, by means of a, preferably tensioned, spring device, and/or is adjusted with a friction connection, in one embodiment by frictionally pressing the sliding contact and/or rotor with the sliding contact arranged thereon against the sliding track, or the sliding track and/or the rotor with the sliding track arranged thereon against the sliding contact by means of the spring device, in particular tensioning the spring device and/or the sliding contact against the sliding track and/or the sliding track against the sliding contact by means of the spring device, in one embodiment by (screwing in) a retaining screw, wherein preferably the retaining screw and the sliding contact (clamped by the same) or the retaining screw and the sliding track (clamped by the same) are not tied to one another or connected to one another.

In one embodiment, this makes it possible to easily and/or reliably cause an adjusted position of the sliding arrangement, in particular of the sliding contact and/or the sliding track, to be lost as a result of a manipulation.

Accordingly, in one embodiment, the friction connection between the sliding contact and the sliding track, preferably the sliding track and the sliding contact, in particular the mounting thereof and/or the spring device, is/are designed such that a frictionally adjusted and/or fixed position of the sliding arrangement, in particular of the sliding contact and the sliding track relative to one another, in one embodiment of the sliding contact relative to and/or on the sliding track or the sliding track relative to and/or on the sliding contact, is lost as a result of a manipulation of the handheld device, in particular of the casing. In one embodiment, the sliding contact is movable, preferably freely, in one or more degrees of freedom, after the friction connection is lost and/or pressing against the sliding track by the spring device has ceased, wherein the position by which the value of the electrical parameter of the sliding arrangement is determined is a position in this or these degree(s) of freedom, and/or the sliding arrangement is designed accordingly, in particular is arranged on, preferably completely or partially in, the casing, in a further development the sliding contact is mounted accordingly. In one embodiment, the sliding track is movable in one or more degrees of freedom, preferably freely, after the friction connection is lost and/or pressing against the sliding contact by the spring device has ceased, wherein the position by which the value of the electrical parameter of the sliding arrangement is determined is a position in this or these degree(s) of freedom, and/or the sliding arrangement is designed accordingly, in particular is arranged on, preferably completely or partially in, the casing, in a further development the sliding track is mounted accordingly.

In one embodiment, the sliding contact, in a further development the rotor with the sliding contact arranged thereon, is connected to the spring device and/or movably, in one embodiment rotatably, mounted by the spring device. In one embodiment, the sliding track, in a further development the rotor with the sliding track arranged thereon, is connected to the spring device and/or movably, in one embodiment rotatably, mounted by the spring device. This allows the sliding arrangement to be realized in a compact and/or simple manner in one embodiment.

In one embodiment, the sliding track is connected to a part of the casing, in a further development arranged on a circuit board connected to this part, preferably the evaluation and/or control device, and the sliding contact is connected to another part of the casing, preferably movably, in particular rotatably, mounted thereon. In one embodiment, the sliding contact is connected to a part of the casing, in a further development arranged on a circuit board connected to this part, preferably the evaluation and/or control device, and the sliding track is connected to another part of the casing, preferably movably, in particular rotatably, mounted thereon. In one embodiment, this allows an at least partial separation of these two casing parts to be detected easily and/or reliably, wherein the arrangement on the circuit board allows a particularly compact design.

As explained, the sliding contact and/or the sliding track can be movably, in particular rotatably, mounted. Particularly preferred is a movable, in particular rotatable, mounting of the sliding contact and/or rotor with the sliding contact arranged thereon on the casing, since in one embodiment this facilitates the determination of the value of the electrical parameter, in particular tapping the sliding track. Accordingly, a position mentioned here, by which a value of an electrical parameter of the sliding arrangement is determined, is particularly preferably a position of the sliding contact, which is movably, in one embodiment, rotatably, mounted on one part of the casing relative to the sliding track arranged or fastened to another part of the casing, without the invention being limited thereto.

In one embodiment, the manipulation reaction comprises restricting, in a further development blocking, a functionality of a or the control device of the handheld device, in one embodiment a boot process of the control device and/or an operation of the robot using the control device.

In one embodiment, this can prevent operation of or with the manipulated handheld device.

Additionally or alternatively, in one embodiment the manipulation reaction comprises an entry in a register which can be accessed or is accessed by a control device of the handheld device, wherein in a further development, this control device, preferably as part of a boot or start process, reads out or queries the register and initiates, in particular executes, a manipulation reaction, in particular a restriction, in particular a blocking or aborting, of a functionality, in particular a boot process (of the control device) and/or an operation of the robot, if it finds at least one entry in the register which indicates a (detected) manipulation; and/or the register and control device are configured for this purpose.

In one embodiment, this makes it possible to reduce power consumption, increase security and/or implement or improve energy-autonomous monitoring of the handheld device for manipulation, particularly when the handheld device is disconnected from an external power supply and/or powered off.

Additionally or alternatively, in one embodiment the manipulation reaction comprises issuing a warning, in a further embodiment an optical and/or acoustic warning and/or to operating personnel and/or (in the form of an electronic entry) in an electronic logbook.

In one embodiment, this can prevent unintentional operation of or with the manipulated handheld device and/or, if necessary, unauthorized manipulation can be detected.

In one embodiment, the evaluation device is or can be activated from a standby state by a signal from the sensor device as a result of a manipulation detected by means of the sensor device, in particular is reactivated or can be reactivated, or the evaluation device and/or sensor device is configured for this purpose. In one embodiment, a standby state is a sleep or hibernation mode or operating state in which energy consumption, a range of functions and/or a clocking of the evaluation device are reduced compared to a (re-)activated (operating) state, in particular one or more functions of the evaluation device are powered off or shut down.

As a result, in one embodiment, the power consumption of the evaluation device responsible for, configured for, or used for carrying out a manipulation reaction as a result of a manipulation detected by means of the sensor device can be reduced; and, in a particularly preferred development, it can be operated by means of a buffered power supply.

Additionally or alternatively, in one embodiment, the evaluation device comprises at least one cryptoprocessor, preferably a low-power or low-voltage cryptoprocessor, particularly preferably an ultra-low-power or ultra-low-voltage cryptoprocessor.

Additionally or alternatively, the evaluation device in one embodiment communicates with the control device and/or the register in an encrypted manner, and/or it/they is/are configured to do so.

As a result, in one embodiment the security can be (further) increased.

In one embodiment, after a manipulation, in particular a manipulation by an entity in one embodiment authorized by the manufacturer of the handheld device, for example, an authorized maintenance person or the like, the evaluation device, the register and/or the stored value of the electrical parameter is changed, in one embodiment is reset or redefined, as a result of communication, preferably encrypted communication, preferably with an or the entity in one embodiment authorized by the manufacturer of the handheld device, and/or the handheld device is configured for this purpose. Resetting the register may in particular comprise deleting entries indicating manipulation, re-defining the stored value of the electrical parameter, in particular re-storing or overwriting the value with a current value which is preferably measured during the reset. In one embodiment, the change and/or communication takes place with or via the control device of the handheld device.

In one embodiment, maintenance can be carried out on the handheld device by authorized personnel and the device can then be put into an operating state in which it is monitored for manipulation in the manner described herein, wherein an opening of the casing by authorized personnel for maintenance purposes does not lead to a manipulation reaction of the evaluation device after this, and/or the register or the value of the electrical parameter (after re-closing the casing) has been reset or redefined or saved as a result of the communication (with the authorized entity).

In one embodiment, the communication comprises sending a request to an authorized entity via the handheld device, preferably its control device, and/or receiving, in particular subsequently, an approval by an or the authorized entity, wherein in one embodiment the evaluation device, the register and/or the stored value of the electrical parameter of the sliding arrangement is/are changed, in particular reset or redefined, by the control device and/or as a result of the approval received.

In one embodiment, the sensor device has a plurality of sensors which are coupled and/or OR-ed together by means of an OR link. In particular, this sensor device signals a manipulation if at least one of its plurality of sensors linked together by means of an OR link detects a manipulation.

As a result, in one embodiment the security can be (further) increased.

Additionally or alternatively, the sensor or one or more of the sensors of the sensor device, in particular a plurality of sensors of the sensor device coupled by means of an OR link, (each) have at least one mechanical or capacitive switch, which in a further development is actuated by a manipulation of the handheld device, in one embodiment of the casing, in particular opening of the casing, or conversely is no longer actuated as a result of a manipulation of the handheld device, in one embodiment of the casing, in particular opening of the casing, and can in particular (each) be such a switch.

As a result, in one embodiment the security can be (further) increased. In particular, a capacitive switch makes it more difficult to mechanically bypass a mechanical switch and can thus (further) increase security.

In one embodiment, during or for the manufacture of the handheld device and/or after a manipulation, in particular a manipulation by an entity in one embodiment authorized by the manufacturer of the handheld device, for example, an authorized maintenance person or the like, the evaluation device is paired with the control device and/or put into a standby state. In one embodiment, pairing the evaluation device and control device comprises creating a crypto key for the encrypted communication between the evaluation device and control device and storing this key in the evaluation device and control device.

The evaluation device and/or the control device has/have in one embodiment at least one processing unit, in particular a digital processing unit, in particular a microprocessor unit (CPU), graphics card (GPU) or the like, which is preferably connected to a storage and/or bus system to exchange data and/or signals, and/or has/have one or more programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program (module) may be designed in such a way that it embodies or is capable of carrying out the methods described herein, such that the processing unit can carry out the steps of such methods.

In one embodiment, operating comprises programming, controlling and/or monitoring, and can in particular be programming, controlling and/or monitoring.

In one embodiment, one or more, in particular all, steps of the method are fully or partially computer-implemented and/or one or more, in particular all, steps of the method are fully or partially automated, in particular by the handheld device and/or its devices.

Both the aspect of the energy store, in particular in connection with the activation of the evaluation device from a standby state, and the aspect of the sliding arrangement, which in one embodiment is irreversibly changed by a manipulation even in the powered off state, such that a manipulation can be detected even after the handheld device has been temporarily powered off, can provide in one embodiment an autonomous manipulation monitoring system which is very particularly suitable for handheld operating devices for operating robots, in particular due to the high safety requirements, complexity and/or maintenance costs.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system for operating a robot, having a handheld operating device according to one embodiment of the present invention;

FIG. 2 schematically depicts a handheld device according to one embodiment of the present invention;

FIG. 3 schematically illustrates a handheld device according to a further embodiment of the present invention;

FIG. 4 illustrates a sliding arrangement of the handheld device of FIG. 3;

FIG. 5 depicts a method for operating the handheld device of FIG. 2 according to an embodiment of the present invention; and

FIG. 6 depicts a method for operating the handheld device of FIG. 3 according to an embodiment of the present invention.

### DETAILED DESCRIPTION

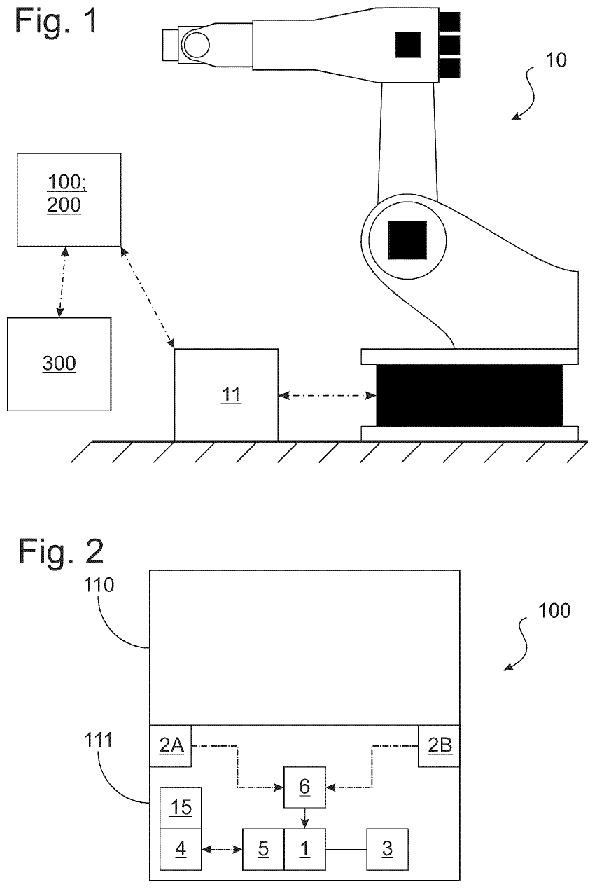

FIG. 1 illustrates a system for operating a robot 10 with a handheld operating device that communicates with a robot controller 11 for this purpose.

FIG. 2 illustrates a handheld device 100 according to an embodiment of the present invention, which may be the handheld operating device of the system of FIG. 1. FIG. 5 illustrates a method for operating this handheld device according to an embodiment of the present invention.

In this embodiment, a plurality of sensors (2A, 2B in FIG. 2 as examples) are integrated in the multi-part casing (in FIG. 2 casing parts 110, 111 connected to one another as examples) of the handheld (operating) device 100. The type of sensors can be selected in different ways. In a simple case, these can be mechanical switching elements, in particular buttons. However, the system could be manipulated with a correspondingly high level of effort by pre-actuating the switching elements one after the other with special tools and holding them in position with a holding frame prepared for this purpose. However, to avoid this risk, switches with capacitive technology can advantageously be used. In this case, the effort required for manipulation and the probability of unintentional triggering of the warning system increases significantly.

The switching elements or sensors 2A, 2B are connected via an OR link 6 to an evaluation device with an ultra-low-power cryptoprocessor 1, which is put into a standby or sleep mode after the initial, factory programming. The communication between a control device 4 with a (main) CPU and the cryptoprocessor is encrypted. The key is created once during production and preprogrammed on both controllers. When one of the switching elements 2A, 2B is triggered, the cryptoprocessor is awakened and a lock flag is set in the locking register 5. The main CPU of the handheld (operating) device sends an encrypted query of the locking register after each boot process. If an active lock flag is returned, the normal boot process is aborted. The locking register can be reset by an authorized programming host 300 via encrypted communication with the cryptoprocessor. If no active flag is returned, the boot process continues and communication with the robot controller 11 is established via a communication interface 15.

In the powered off state, the cryptoprocessor 1 is supplied by an energy store in the form of an additional buffer voltage source or buffer battery 3. This can in particular comprise a Li-ion cell or capacitive storage cell or be implemented using another technology.

FIG. 5 a) shows method steps carried out by or with the control device 4 or its (main) CPU; FIG. 5 b) shows steps carried out by or with the evaluation device 1 or its cryptoprocessor.

In step S10, the control device or (main) CPU is initially programmed, in particular paired with the evaluation device or the cryptoprocessor, and the sensors 2A, 2B are activated.

In step S11 a boot process is started. In a step S12, the control device or its (main) CPU queries the register 5 to determine whether an active flag is set. If this is not the case (S12: “N”), the boot process is carried out or continued (step S17).

If the query results in at least one active flag (S12: “Y”), the boot process is interrupted and a reset routine is started (step S13). The control device or (main) CPU sends a request to an authorized entity (step S14). As soon as it receives approval from the authorized entity (step S15), it resets the register 5 or clears the active flag(s) (step S16). The boot process can then be carried out or continued (step S17).

Accordingly, in step S20, the evaluation device or the cryptoprocessor is initially programmed and initialized, in particular paired with the control device or (main) CPU.

In a step S21, any active flags in the register 5 are reset.

The evaluation device or the cryptoprocessor is then put into a standby state (step S22). As long as none of the sensors 2A, 2B is activated (S23: “N”), this standby state is maintained.

If the evaluation device or the cryptoprocessor is (re-)activated or triggered by at least one of the OR-ed sensors 2A, 2B (S23: “Y”), it sets an active flag in the register 5 (step S24).

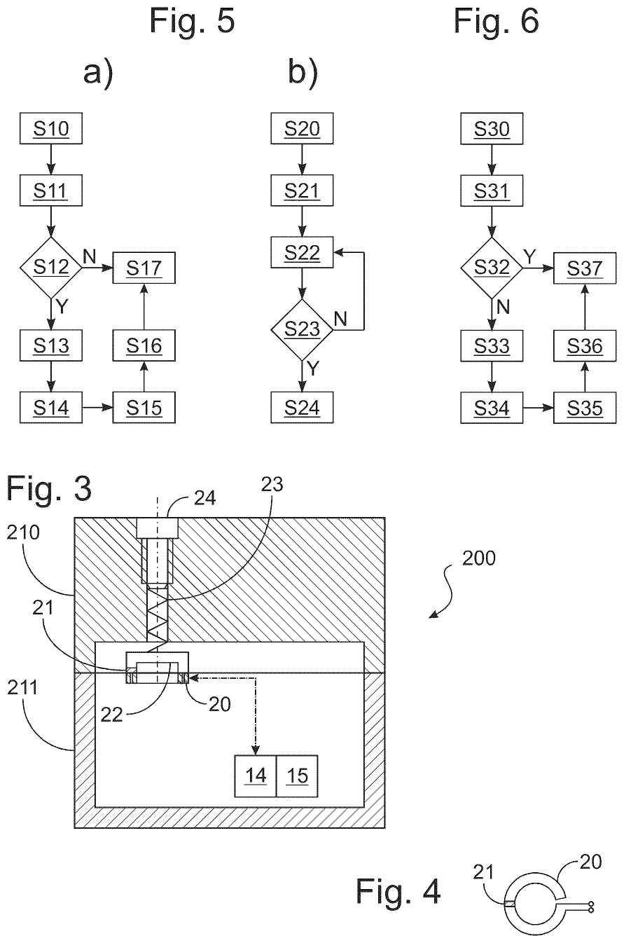

FIG. 3 illustrates a handheld device 200 according to a further embodiment of the present invention in a lateral section, which can also be the handheld operating device of the system of FIG. 1; FIG. 6 shows a method for operating this handheld device according to an embodiment of the present invention; Fig. depicts shows a sliding arrangement of the handheld operating device in a schematic plan view. In contrast to the above embodiment with buffered power supply explained with reference to FIG. 2, 5, this embodiment realizes manipulation monitoring without additional power supply.

This embodiment uses an irreversibly changing sensor in the form of a sliding arrangement, which is triggered when the device is manipulated.

The sensor has the following structure: Two parallel paths of a ring-shaped sliding track 20 (see FIG. 4) are integrated on a circuit board (not shown) located in the handheld device. The sensor value is defined by the electrical resistance measured between the two tracks or their connections, indicated by circles in FIG. 4. The rotational position of a sliding contact 21 arranged on a rotor 22 determines the value. During factory assembly of the device, the sliding contact 21 takes a random position. By means of a spring 23 fixedly mounted on the rotor 22, it is rotatably mounted and held in position by friction. The spring 23 is tensioned by means of a retaining screw 24 which is screwed into the upper casing shell 210. The spring 23 is not tied to the screw 24. After the upper and lower casing shells 210, 211 have been assembled, the current resistance value between the sliding paths of the sliding track 20 is measured and initially preprogrammed in encrypted form (FIG. 6: step S30). Manipulation of the device casing, in particular unscrewing the casing shells 210, 211, leads to a loss of spring tension and thus to a loss or change of the position of the sliding contact 21, since the rotor 22 can rotate and the sliding contact 21 contacts the sliding track 20 in a different position when the casing shells 210, 211 are reassembled, resulting in a changed resistance value.

The value of the sensor is read out during each boot process by an evaluation device 14, which can be integrated into the main CPU of the handheld (operating) device or can be identical thereto (step S31) and compared with the preprogrammed value (step S32).

If the values match (S32: “Y”), the boot process continues and communication with the robot controller 11 is established via a communication interface 15 (step S37).

If the values do not match (S32: “N”), the normal boot process is aborted (step S33). The current value of the sensor can be read out and preprogrammed via encrypted communication with the programming host. As explained above with reference to FIG. 5 a), a request is sent to an authorized entity in the form of the programming host (step S34). As soon as it receives approval from the authorized entity (step S35), the current resistance value between the sliding paths of the sliding track 20 is measured and stored as the new value of the electrical parameter of the sliding arrangement determined by the position of the sliding contact 21 (step S36). The boot process can then be carried out or continued (step S37).

Although exemplary embodiments have been explained in the preceding description, it is pointed out that a large number of modifications is possible.

For example, in a variation, the sending of the request (step S14 or S34) can be omitted, wherein a response is only made to an approval.

Similarly, in contrast to the construction of FIG. 3, 4, the sliding track can be rotatably mounted on a rotor and tensioned or pressed against the sliding contact by a spring device. However, the arrangement shown in FIG. 3, 4 has the advantage that the resistance value at the sliding track 20 on the circuit board (not shown) can be determined or measured more easily and/or reliably.

It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

List of reference signs

| | |
|---|---|
| 1 | evaluation device (cryptoprocessor) |
| 2A, 2B | sensor |
| 3 | buffer battery (energy store) |
| 4 | (main) CPU (control device) |
| 5 | register |
| 6 | OR coupling |
| 10 | robot |
| 11 | robot controller |
| 14 | evaluation and control device |
| 15 | communication interface |
| 20 | sliding track with two parallel paths |

1. Handheld device (100; 200) having a casing (110, 111; 210, 211), a sensor device arranged on the casing with at least one sensor (2A, 2B; 20, 21) for detecting a manipulation of the handheld device, in particular of the casing, and an evaluation device (1; 14) arranged on the casing for initiating, in particular executing, a manipulation reaction as a result of a manipulation detected by means of the sensor device, wherein the handheld device is a handheld operating device for operating a robot (10) and/or the handheld device has at least one energy store (3) arranged on the casing for supplying the evaluation device with electrical energy, and/or the sensor has a sliding arrangement with at least one sliding track (20) and at least one sliding contact (21) for producing an electrical contact with this sliding track in a variably adjustable position, wherein a value of an electrical parameter of the sliding arrangement determined by this position is stored and/or the sliding arrangement is designed such that this position is lost as a result of manipulation.

2-13. (canceled)

14. Handheld device according to claim 1, characterized in that the manipulation reaction comprises restricting, in particular blocking, a functionality, in particular a boot process and/or an operation of the robot, a control device (4; 14) of the handheld device, an entry in a register (5) which can be accessed by a control device (4) of the handheld device, and/or issuing a warning.

15. Handheld device according to claim 1, characterized in that the evaluation device can be activated from a standby state by a signal from the sensor device as a result of a manipulation detected by means of the sensor device, and/or has at least one cryptoprocessor (1) and/or is configured for encrypted communication with the control device and/or the register, and/or, after manipulation, the evaluation device, the register and/or the stored value of the electrical parameter can be changed, in particular reset or redefined, as a result of communication, in particular encrypted communication.

16. Handheld device according to claim 1, characterized in that the sensor device has a plurality of sensors coupled by means of an OR link (6) for detecting a manipulation of the handheld device, in particular of the casing, and/or at least one sensor of the sensor device for detecting a manipulation of the handheld device, in particular of the casing, has at least one mechanical or capacitive switch.

17. Handheld device according to claim 1, characterized in that the sliding track is ring-shaped and/or the position of the sliding arrangement is adjusted by means of a spring device (23) and/or frictionally, and/or the sliding contact and/or the sliding track is/are mounted movably, in particular rotatably, in particular is/are arranged on a rotatably mounted rotor (22).

18. Handheld device characterized in that it is configured to be operated, in particular is operated, according to the method of claim 21.

19. System for operating a robot (10), comprising a handheld operating device according to claim 1, which has a communication interface (15) for communicating with the robot and/or a robot controller (11) for controlling the robot.

20. Method for producing a handheld device (100; 200) according to claim 1, wherein the evaluation device is paired with the control device (S10, S20) and/or put into a standby state (S22), and/or the position of the sliding arrangement is adjusted, in particular randomly, and/or the value of the electrical parameter of the sliding arrangement determined by this position is stored (S30).

21. Method for operating a handheld device (100; 200) according to claim 1, wherein the handheld device outputs signals for operating the robot (10) as a result of user inputs, and/or the evaluation device is supplied with electrical energy by the energy store (3) and/or is activated from a standby state by a signal from the sensor device as a result of a manipulation detected by means of the sensor device (S23), and/or the control device queries the register (S12) and, if there is at least one entry indicating manipulation, initiates, in particular executes, a manipulation reaction, in particular a restriction, in particular a blocking or aborting, of a functionality, in particular a boot process and/or an operation of the robot, and/or the evaluation device compares a detected value of the electrical parameter of the sliding arrangement with the stored value of the electrical parameter (S32) and detects a manipulation if a deviation between the detected and stored value of the electrical parameter fulfills a deviation condition.

22. Method according to claim 21, characterized in that the evaluation device initiates, in particular executes, a manipulation reaction as a result of a manipulation detected by means of the sensor device, in particular a restriction, in particular a blocking, of a functionality, in particular a boot process and/or an operation of the robot, of a control device of the handheld device, an entry in a register which is accessed by a control device of the handheld device, and/or issuing a warning.

23. Method according to claim 21, characterized in that the evaluation device (1) communicates with the control device (4) and/or the register (5) in an encrypted manner.

24. Method according to claim 21, characterized in that, after a manipulation, the evaluation device (1; 14), the register (5), and/or the stored value of the electrical parameter of the sliding arrangement (20, 21) is/are changed, in particular reset or redefined (S16; S36) as a result of communication, in particular encrypted communication.

25. Method according to claim 24, characterized in that the communication comprises sending (S14; S34) a request to an authorized entity (300) by the handheld device and/or receiving an approval (S15; S35) by the authorized entity.
